(19) United States
(12) Patent Application Publication
(10) Pub. No.: US 2007/0202471 A1
(43) Pub. Date: Aug. 30, 2007

(54) FLAT PANEL DISPLAY HAVING A REMOTE INTERFACE CONTROLLED BY A COMPUTER

(76) Inventor: Fernando Petruzziello, Montréal, QC (CA)

Correspondence Address: BERESKIN AND PARR, 40 KING STREET WEST, BOX 401, TORONTO, ON, M5H 3Y2, CA

(21) Appl. No.: 11/558,654

(22) Filed: Nov. 10, 2006

Related U.S. Application Data
(63) Continuation-in-part of application No. PCT/CA05/00746, filed on May 10, 2005.

(30) Foreign Application Priority Data
May 10, 2004 (CA) 2467008

(51) Int. Cl. G09B 9/08; G09B 19/16

(52) U.S. Cl. 434/30; 434/36

(57) ABSTRACT

A simulator instrumentation system comprises a flat panel display and an overlay placed over the flat panel display. A controller is functionally connected to the flat panel display for controlling an image characteristic of the flat panel display. The controller is connected to a contact switch. A method of controlling an image characteristic of a flat panel display comprises the steps of connecting a controller to a contact switch of a flat panel display and simulating an input sequence of a contact switch using the controller.

This application is a continuation-in-part of PCT application No. PCT/CA2005/000746 filed on May 10, 2005, hereby incorporated by reference.

### FIELD OF THE INVENTION

The present invention generally relates to the field of computer-aided training devices of the type commonly referred to as simulators and, in particular to instrumentation systems for such simulators. Training devices of this type include simulators for vehicles such as transport aircraft, ships and large land vehicles and simulators for fixed station facilities such as power generators and chemical processes. More specifically, the present invention relates to flat panel displays having a remote interface controlled by a controller such that image characteristics of the flat panel displays may be adjusted remotely by the controller.

### BACKGROUND OF THE INVENTION

Training devices or simulators present situations to a trainee to allow the trainee to practice some task, such as operating an airplane. In an aircraft simulator, for example, a pilot trainee sits in a reproduction of a real aircraft cockpit. An instructor influences the unfolding of the training mission by interacting with the computer which is managing the simulation. For the aeronautic industry, there exists different types of simulators for meeting the different simulation requirement levels of the authorities. The highest level of simulation requires that the whole cockpit of an aircraft be reproduced with the exact same components than those used in the actual aircraft. A lower level of simulator does not require that the components, such as the instruments, be the exact same component as used in an actual aircraft, but must still be reproduced aesthetically and functionally. A still lower level of simulators does not require that the instrument be exactly reproduced aesthetically, but must still be located in the same position as in the actual aircraft. The present invention is specifically directed to the types of simulator not requiring to use the exact same instruments as used in an actual aircraft.

In prior art simulators, it has been known to use flat panel displays behind overlays to simulate instruments. Typically, a single flat panel is used to simulate more than one instrument at once. The simulator often use many flat panel displays to simulate the environment, for example, the whole cockpit of an aircraft.

During a simulation, it may be required to alter the image characteristics of the flat panels displays. For instance, during night time, the trainee may want to dim the instruments. This is presently done by reaching the image control buttons of each single flat panel display and manually dimming the screen. This is obviously not how it would be done in a real aircraft and greatly diminishes the realism of the simulator. Furthermore, it takes more time to adjust the screens this way than it would take to dim the instruments in real life, distracting the trainee longer. Moreover, the trainee is more prone to adjust the screens differently, which would not be the case in real life where a single control would adjust many instruments at once.

There is therefore a need for an improved simulator instrumentation system, of the type not requiring the use the exact same instruments as in real applications, which allows a higher level of realism.

### SUMMARY OF THE INVENTION

It is an object of the invention to provide a simulator instrumentation system that solves the problems of prior art.

It is a further object of the invention to provide a simulator instrumentation system that increases the realism of the simulator.

It is a further object of the invention to provide a simulator instrumentation system that reduces the time it takes to adjust an image characteristic of the screen of a flat panel display.

It is a further object of the invention to provide a simulator instrumentation system that requires an amount of trainee intervention similar to a real life application.

In accordance with an embodiment of the present invention, there is provided a simulator instrumentation system comprising a flat panel display, an overlay placed over the flat panel display and a controller functionally connected to the flat panel display for controlling an image characteristic of the flat panel display. Preferably, the controller is connected to a contact switch. More preferably, the controller controls the image characteristics of the flat panel display by simulating an input sequence from the contact switch. The controller may communicate to the simulator over a network. Most preferably, the controller controls the image characteristic based on a simulation performed by the simulator. The image characteristic may be brightness.

Alternatively, the simulator instrumentation system further comprises an instrumentation interface operative to send a signal to the controller, the controller controlling the image characteristic of the flat panel display based on the signal. Preferably, the instrumentation interface is located on the overlay. The flat panel display may be equipped with a gauge area and the overlay may be equipped with at least one opening so that when the overlay is placed over the flat panel display, the gauge area is visible through the opening.

Preferably the overlay further comprises bezels surrounding the openings so as to simulate the look of a real instrument. More preferably, the simulated instrument is an aircraft instrument.

In accordance with another embodiment of the present invention, there is provided a method of controlling an image characteristic of a flat panel display comprising the steps of connecting a controller to a contact switch of a flat panel display and simulating a input sequence of a contact switch using the controller. Preferably, the method further comprises the step of covering the flat panel display with an overlay for simulating an instrument. More preferably, the method further comprises the step of connecting the controller to an instrumentation interface. Even more preferably, the method further comprises the step of controlling the image characteristic based on a signal received from the instrumentation interface. Most preferably, the method comprises the step of controlling the image characteristic based on a simulation.

The invention provides a low cost alternative to using real simulator instruments.

### BRIEF DESCRIPTION OF DRAWINGS

These and other features of the present invention will become more apparent from the following description in which reference is made to the appended drawings wherein:

FIG. 1 is an isometric view of a simulator instrumentation system in accordance with an embodiment of the present invention;

FIG. 2 is schematic view of the simulator instrumentation system of FIG. 1.

### DETAILED DESCRIPTION OF THE INVENTION

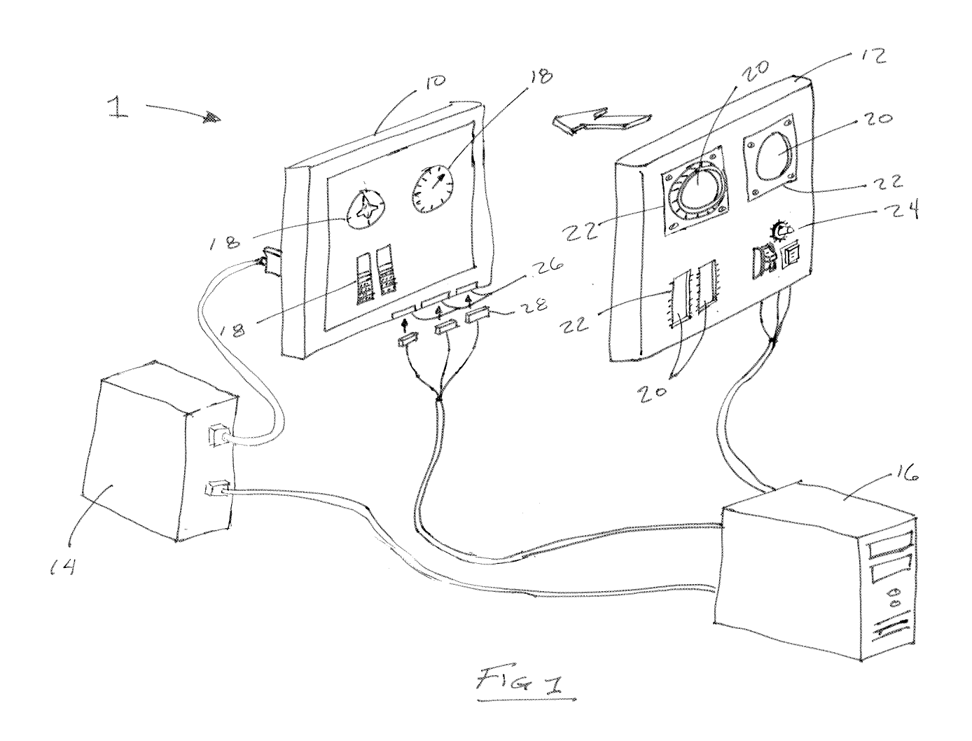

FIG. 1 depicts the simulator instrumentation system 1 which comprises a flat panel display 10 and an overlay 12. Such an instrument system is used in simulators when it is not required to use the exact same instrumentation as in real life applications. In the present case, a flat panel display is covered by an overlay 12 to mimic actual instrumentation. The flat panel display 10 is connected to a computer 14 controlling the simulation and to a controller 16, which may also be a computer. The computer 14 manages the display of information on the screen of the flat panel display 10 such as the gauge areas 18. A single flat panel display 10 may indeed replace more than one instrument by being able to display many gauge areas 16 on its screen. Openings 20 located in the overlay 12 match the gauge areas 18 such that when the overlay is placed over the flat panel 10, it aesthetically looks like an actual instrumentation panel containing real instruments. Bezels 22 surrounding the openings 20 add to the realism of the instrumentation system 1. The overlay may also comprise an instrumentation interface 24.

The controller 16 is used to control the image characteristics of the flat panel 10. Such image characteristics are standard image characteristics that may be adjusted on a flat panel display, such as brightness or contrast, for example. The controller 16 is connected to the flat panel display 10 through its contact switches 26. This advantageously allow the use of standard flat panel displays. Actually, the mechanical part of the control switches is removed and connectors 28 are connected in place of the contact switches 26.

The instrumentation interface 24 is an interface for a trainee to adjust the image characteristics of his instruments. For example, the trainee may want to dim his instruments. The trainee adjusts the instrumentation interface 24, which then sends a signal to the controller 16. The controller 16 translates the signal into an equivalent sequence of electrical inputs that simulates the mechanical inputs that the trainee would have had to perform had he used directly the contact switches 26 of the flat panel display 10.

The computer 14 is also connected to the controller 16. During a simulation, the computer may have to adjust an image characteristic. Similarly to the signal sent by the instrumentation interface 24, the computer 14 sends a signal to the controller 16 to adjust an image characteristic to a certain level.

When the simulator is turned on, the controller 16 zeros all image characteristics of the display panels it controls and then brings these image characteristics to default values. During simulation, if for instance the trainee adjusts the instrumentation interface 24 to get a 60% brightness of his instruments, the controller 16 then sends a sequence of electrical inputs to the right contacts switches 26 to vary the brightness from its default value the new value of 60%. The controller then stores in its memory that 60% value as the current brightness value.

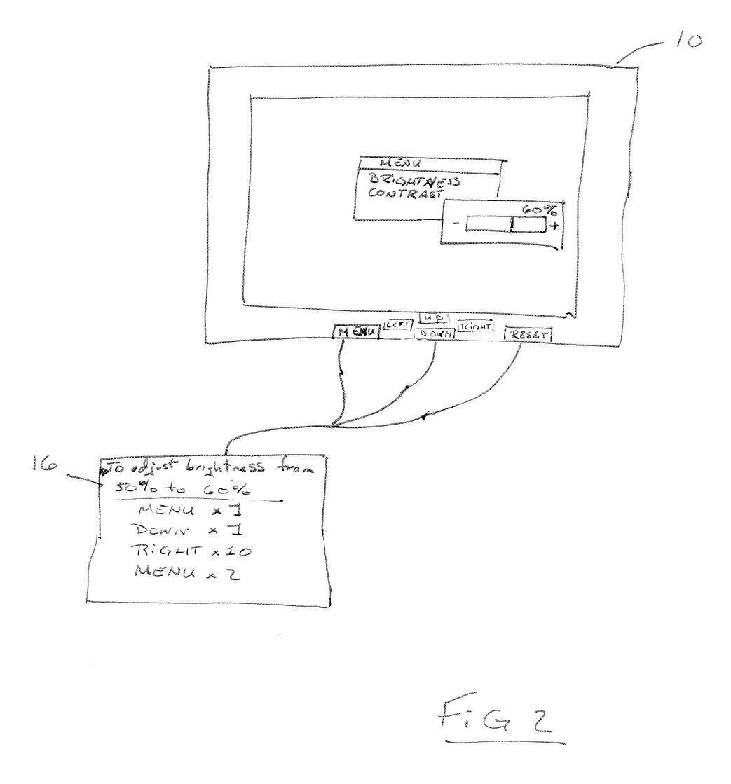

FIG. 2 shows schematically how the controller 16 builds its sequence. Using the same example as previously, if the default value for brightness was 50%, then the controller 16 would build the following sequence: 1×MENU, 1×DOWN, 10×RIGHT (assuming a 1% increase per input) and 2×MENU to exit this function.

If the flat panel display 10 is so equipped, the zeroing at the beginning of the simulation may be achieved by inputting a single RESET signal, which brings all values of the image characteristics to their default values.

The instrumentation interface does not have to be installed on the overlay 12. It has to be placed at the same position it is placed in the actual aircraft which may be somewhere where no overlay is used.

Just as the computer 14 may control the information displayed on more than one flat panel display 10, the controller may control the image characteristics of some or all of the flat panel displays 10 used in a simulator.

The present invention has been described with regard to preferred embodiments. The description as much as the drawings were intended to help the understanding of the invention, rather than to limit its scope. It will be apparent to one skilled in the art that various modifications may be made to the invention without departing from the scope of the invention as described herein, and such modifications are intended to be covered by the present description.

I claim:

1. A simulator instrumentation system comprising:
a flat panel display;
an overlay placed over said flat panel display;
a controller functionally connected to said flat panel display for controlling an image characteristic of said flat panel display.

2. A system as defined in claim 1 wherein said controller is connected to a contact switch.

3. A system as defined in claim 2 wherein said controller controls said image characteristics of said flat panel display by simulating an input sequence from said contact switch.

4. A system as defined in claim 3 wherein said controller communicates to the simulator over a network.

5. A system as defined in claim 4 wherein said controller controls said image characteristic based on a simulation performed by the simulator.

6. A system as defined in claim 5 wherein said image characteristic is brightness.

7. A system as defined in claim 1 further comprising an instrumentation interface operative to send a signal to said controller, said controller controlling said image characteristic of said flat panel display based on said signal.

8. A system as defined in claim 7 wherein said instrumentation interface is located on said overlay.

9. A system as defined in claim 1 wherein said flat panel display is equipped with a gauge area and said overlay is equipped with at least one opening so that when said overlay is placed over said flat panel display, said gauge area is visible through said opening.

10. A system as defined in claim 9 wherein said overlay further comprises bezels surrounding said openings so as to simulate the look of a real instrument.

11. A system as defined in claim 10 wherein said simulated instrument is an aircraft instrument.

12. A method of controlling an image characteristic of a flat panel display comprising the steps of:
connecting a controller to a contact switch of a flat panel display;
simulating a input sequence of a contact switch using said controller.

13. A method as defined in claim 12 further comprising the step of covering said flat panel display with an overlay for simulating an instrument.

14. A method as defined in claim 13 further comprising the step of connecting said controller to an instrumentation interface.

15. A method as defined in claim 14 further comprising the step of controlling the image characteristic based on a signal received from said instrumentation interface.

16. A method as defined in claim 15 further comprising the step of controlling the image characteristic based on a simulation.
